(19) United States
(12) Patent Application Publication
(10) Pub. No.: US 2025/0328347 A1
(43) Pub. Date: Oct. 23, 2025

(54) HALTING INSTRUCTION EXECUTION

(71) Applicant: Arm Limited, Cambridge (GB)

(72) Inventors: Brendan James MORAN, Coton (GB); Michael BARTLING, Austin, TX (US); Andreas Lars SANDBERG, Cambridge (GB)

(21) Appl. No.: 18/640,767

(22) Filed: Apr. 19, 2024

(51) Int. Cl. G06F 9/30; G06F 12/1009

(52) U.S. Cl. CPC G06F 9/30047; G06F 9/30043

(57) ABSTRACT

A data processing apparatus is provided that includes storage circuitry for storing a data value derived from a plurality of memory addresses associated with a stream of instructions. Membership query circuitry performs an approximate set membership query against the data value of a memory address associated with a current one of the instructions and in response to the approximate set membership query being positive, issues the memory address to confirmation circuitry. Halt circuitry halts execution of the stream of instructions by processing circuitry in response to at least one condition being met, the at least one condition including a positive indication from the confirmation circuitry that the memory address is one of the plurality of memory addresses.

### TECHNICAL FIELD

The present disclosure relates to data processing such as in debugging.

### DESCRIPTION

In debugging it may be desirable to have lots of halting points (either breakpoints or watchpoints). However, adding several such halting points can be problematic and can result in larger circuits or slow debugging.

### SUMMARY

According to one example, there is provided a data processing apparatus comprising: storage circuitry configured to store a data value derived from a plurality of memory addresses associated with a stream of instructions; membership query circuitry configured to perform an approximate set membership query against the data value of a memory address associated with a current one of the instructions and in response to the approximate set membership query being positive, to issue the memory address to confirmation circuitry; and halt circuitry configured to halt execution of the stream of instructions by processing circuitry in response to at least one condition being met, the at least one condition comprising a positive indication from the confirmation circuitry that the memory address is one of the plurality of memory addresses.

According to one example, there is provided a method comprising: storing a data value derived from a plurality of memory addresses associated with a stream of instructions; performing an approximate set membership query against the data value of a memory address associated with a current one of the instructions and in response to the approximate set membership query being positive, to issue the memory address to confirmation circuitry; and halting execution of the stream of instructions by processing circuitry in response to at least one condition being met, the at least one condition comprising a positive indication from the confirmation circuitry that the memory address is one of the plurality of memory addresses.

According to one example, there is provided a non-transitory computer-readable medium storing computer-readable code for fabrication of a data processing apparatus comprising: storage circuitry configured to store a data value derived from a plurality of memory addresses associated with a stream of instructions; membership query circuitry configured to perform an approximate set membership query against the data value of a memory address associated with a current one of the instructions and in response to the approximate set membership query being positive, to issue the memory address to confirmation circuitry; and halt circuitry configured to halt execution of the stream of instructions by processing circuitry in response to at least one condition being met, the at least one condition comprising a positive indication from the confirmation circuitry that the memory address is one of the plurality of memory addresses.

According to one example, there is provided a system comprising: the data processing apparatus of any one of claims 1-16, implemented in at least one packaged chip; at least one system component; and a board, wherein the at least one packaged chip and the at least one system component are assembled on the board.

According to one example, there is provided a chip-containing product comprising the system of claim 19, wherein the system is assembled on a further board with at least one other product component.

### BRIEF DESCRIPTION OF THE DRAWINGS

The present invention will be described further, by way of example only, with reference to embodiments thereof as illustrated in the accompanying drawings, in which:

FIG. 1 illustrates an apparatus in accordance with some examples;

FIG. 2 shows an example in which the confirmation circuitry takes the form of the pipeline;

FIG. 3 shows an example of how an approximate set membership query might work;

FIG. 4 illustrates how proper set membership can then be tested for using confirmation circuitry;

FIG. 5 shows a flow chart that allows for further improvements in the checking that is performed;

FIG. 6A illustrates one way in which page tables can be used to improve the previously described process;

FIG. 6B illustrates an example that allows for the use of multiple data values;

FIG. 6C illustrates an example in which the data value 34 is dynamically constructed;

FIG. 7 illustrates an example of using speculative execution that can be used to improve the execution when a query is made to the confirmation circuitry, whose use is generally slow;

FIG. 8 shows a flowchart that can be used for memoisation; and

FIG. 9 shows a flowchart that shows an overall process of data processing in accordance with some examples; and

FIG. 10 shows the apparatus on one chip or distributed over two or more of the chips.

### DESCRIPTION OF EXAMPLE EMBODIMENTS

Before discussing the embodiments with reference to the accompanying figures, the following description of embodiments is provided.

There is provided a data processing apparatus comprising: storage circuitry configured to store a data value derived from a plurality of memory addresses associated with a stream of instructions; membership query circuitry configured to perform an approximate set membership query against the data value of a memory address associated with a current one of the instructions and in response to the approximate set membership query being positive, to issue the memory address to confirmation circuitry; and halt circuitry configured to halt execution of the stream of instructions by processing circuitry in response to at least one condition being met, the at least one condition comprising a positive indication from the confirmation circuitry that the memory address is one of the plurality of memory addresses.

The present technique recognises that in, for instance, a debugging system it may be desirable to halt execution of a stream of instructions based on a memory address associated with one of the instructions. However, checking every memory address associated with every instruction against a list of ‘halting’ addresses can be problematic. In particular, to check each address in series is very time consuming and since such a check may have to be performed for every instruction, this would significantly slow down execution of the instruction stream. On the other hand, allowing all checks to occur in parallel would lead to an extremely large circuit size. The present technique resolves this by the use of an approximate set membership query. Rather than being a perfect set membership query (i.e. is this particular address in the set of ‘halting’ addresses), the set membership query is approximate. It will indicate whether the address is (a) not in the set or (b) possibly in the set. If an address is not in the set, then execution can continue. If the address is possibly in the set then a more thorough/accurate set membership query can be performed using the confirmation circuitry. This is particularly convenient because although the more thorough/accurate set membership query performed by the confirmation circuitry might be slow, this is generally not a problem if the instruction is one that causes a halt. Meanwhile, provided the proper match query is only performed infrequently, it may not be significant if it is run unnecessarily—i.e. for an address that is actually not in the set of halting addresses. Importantly, the set membership query can be both designed to limit the theoretical probability of false positives, query results returned as possible in the set despite never being added prior, while also being performed more quickly than the more accurate check performed by the confirmation circuitry, even against a large set. Furthermore, it can be performed for a large set without the need for significant circuitry. Overall, therefore, this makes it possible to halt when any one of a large set of addresses is encountered. Note that the term ‘positive’ in this context refers to whatever refers to positive in the context of an approximate set membership query and indicates the opposite of a negative result. It does not confer any element of certainty and indeed, an approximate set membership query may be incapable of indicating certainty with a positive result. That is to say that the positive result might be ‘maybe’ as opposed to the negative result ‘no’.

In some examples, the memory addresses comprise program counter values of those of the instructions at which a breakpoint is set. A breakpoint is a point in a program where a programmer desires the execution of the program to halt, e.g. so that the state of the system such as the values held by particular variables can be analysed. The memory addresses associated with instructions could therefore include the program counter values of particular instructions where execution is to stop. Program counter values are memory addresses by virtue of the memory address at which a particular instruction is stored in memory.

In some examples, the memory addresses comprise locations within a memory at which data access requests are made by the instructions against which a watchpoint is set. Watchpoints can be set against particular variables, which will cause the program to halt execution when that variable changes (or, more likely, when one or more conditions set in respect of the variable are met, such as halting when the variable is greater than a threshold). Here, the memory address that is associated with the instructions could be a memory address that is accessed (e.g. read or written to) by that instruction, with the memory address corresponding with a location in memory where the variable is held.

In some examples, the data processing apparatus comprises: the confirmation circuitry, wherein the confirmation circuitry is configured to store a further data value indicating the plurality of memory addresses. The data value could, for instance, be a list of the memory addresses against which execution is to halt. In this example, the confirmation circuitry comprises hardware, which performs the confirmation check.

In some examples, in response to the approximate set membership query being positive, the membership query circuitry is configured to issue a signal to the confirmation circuitry; and a signal receiving routine at the confirmation circuitry is configured to determine whether the memory address is in the plurality of memory addresses. In these examples, the confirmation circuitry could take the form of processing circuitry that executes software (the signal receiving routine) that performs the confirmation of set membership.

In some examples, at least one of the membership query circuitry and the confirmation circuitry is configured to return a negative result indicating that the memory address is not one of the memory addresses in response to the memory address being below a lower limit. A further check that can be performed is whether the memory address is lower than the lower limit. This makes it possible to reduce the circumstances in which the approximate set membership query or the confirmation check from the confirmation circuitry is to be performed and the at least one of the membership query circuitry and the confirmation circuitry may therefore not actually have a check performed. Furthermore, this restriction can be used to provide control over the data value. In particular, if it is known that the memory address will not be in large portions of the memory space will not be used, then this can be handled by a range check rather than using the data value. Thus, the data value would only have to span across a smaller address space, which makes it possible to improve the accuracy of the approximate set membership query provided that it is generated appropriately. For instance, bits of the address space that will never contain any memory address could be disregarded when generating and querying the data value. The lower limit might therefore be the lower or upper end of a page.

In some examples, at least one of the membership query circuitry and the confirmation circuitry is configured to return a negative result indicating that the memory address is not one of the memory addresses in response to the memory address being above an upper limit. As explained above, by placing checks on the bounds of the memory address, it is possible to reduce the checks that might otherwise be performed (i.e. either by the confirmation circuitry or the membership query circuitry) and potentially improve the accuracy of the data value in performing the approximate set membership query. As explained above, the upper limit might be the lower or upper end of a page.

In some examples, at least one of the membership query circuitry and the confirmation circuitry is configured to return a negative result indicating that the memory address is not one of the memory addresses based on memory page metadata of the memory address. In some examples, the output of the confirmation circuitry and/or of the membership query circuitry is influenced by the memory page that contains the memory address.

In some examples, the data processing apparatus comprises: page table circuitry configured to store a plurality of page table entries, wherein of the page table entries is configured to store an indication of whether a corresponding memory page contains one of the memory addresses. One way of relating the pages to the approximate membership set query and/or membership query is to store data in the page tables. A page table entry typically relates to one page of memory, which itself can cover a number of memory addresses. Within the page table entry, a bit can be provided to indicate whether the page contains one of the memory addresses. For instance, the value ‘1’ can indicate that the page does contain an address covered by the data value and a ‘0’ can indicate otherwise. In this way, it is possible to provide a further confirmation that a particular address may be in the plurality of memory addresses without performing the full membership test. For instance, if the approximate set membership query indicates that a memory address may be one of the plurality of addresses then before the confirmation circuitry is queried (which can be time consuming), a check of the relevant memory page can be made. If the page table entry for the page containing the memory address indicates that the page does not contain a memory address that is one of the memory addresses then there is no need for the confirmation circuitry to be queried, otherwise the confirmation circuitry can be queried with a greater confidence that the memory address is one of the memory addresses.

In some examples, the data processing apparatus comprises: page table circuitry configured to store a plurality of page table entries, wherein the membership query circuitry is configured to perform the approximate set membership query against a plurality of data values including the data value; and the page table entries comprise a hint that indicates a set of the plurality of data values against which the approximate set membership query is to be performed for the memory address. Each of the page table entries could therefore include an indicator that provides the hint as to which of the data values should be used for the approximate set membership query. This could be implemented, for instance, as a bitfield that indicates which data value(s) to use for the approximate set membership query. This makes it possible to expand the accuracy of the approximate set membership query by reducing the number of entries within each data value.

In some examples, the data processing apparatus comprises: update circuitry configured to store an outcome of one or both of the membership query circuitry and the confirmation circuitry for one of the page tables in response to execution of instructions corresponding to the one of the page tables. The updating circuitry can therefore be used in order to indicate the outcome of the approximate membership query and/or the membership query so that such analysis can be performed in advance. This makes it possible to reduce the impact of set membership queries performed with the confirmation circuitry that indicate a memory address is not one of the memory addresses at which a halt in execution should be performed. Since this membership check is time consuming, performing it at a time when it may have little to no impact on processing and storing the result for later use, could be useful to improving the processing throughput. The result of the outcomes could be stored, for instance, in page table entries so that if an address in a particular page was determined to return a positive result (from the approximate membership query and/or the membership query) then that page is updated.

In some examples, in response to issuing the memory address to the confirmation circuitry, the data processing apparatus is configured to enter a speculative mode of operation in which those of the instructions after the current one of the instructions are executed speculatively until a response from the confirmation circuitry is received. As already noted, the confirmation circuitry can take time in order to provide an answer to a set membership query—that is, to confirm (with certainty) whether the memory address is one of the memory addresses that causes a halt in the execution. Consequently, rather than terminating execution until such time as the query is resolved, it is possible to begin executing subsequent instructions speculatively. If it turns out that the memory address was not one of the memory addresses that causes a halt in execution then little to no performance penalty has been incurred—the speculatively execution instructions are simply committed. However, if the memory address is determined to be one of the addresses that does cause execution to halt then execution would have been halted in any event and so the fact that the later instructions are not executed is not detrimental.

In some examples, the data processing apparatus is configured, in response to the confirmation circuitry determining that the memory address is one of the memory addresses, to perform a rewind on those of the instructions after the current one of the instructions, that were speculatively executed. Where speculative execution takes place, a determination that a halt should have occurred causes a rewind to take place so that the speculatively executed instructions are effectively not executed.

In some examples, the data processing apparatus comprises: cache circuitry, wherein at least one of the membership query circuitry and the confirmation circuitry is configured to determine whether given memory addresses whose contents are stored in the cache circuitry are in the plurality of memory addresses, in response to a cache miss. The cache could, for instance, be an instruction cache. In this situation, a cache miss generally requires further instructions to be fetched into the cache so that they can be decoded and executed and this generally indicates a lull in processing will take place. This therefore provides an opportunity to perform the approximate set membership query and/or the set membership query to take place without negatively impacting the processing performance. As an alternative, the cache could be a data cache in which filling the data cache (in response to a miss) causes the addresses of data in the cache to be tested to determine whether they are among the addresses for which a halt should (might) be called.

In some examples, the cache circuitry is configured to store an indication of whether the given memory addresses are in the plurality of memory addresses. Thus, set membership can be indicated for each instruction at a convenient time without the need for an (approximate) set membership query to take place at the time of execution. Instead, the membership (or approximate membership) can be calculated ahead of time and an indication of membership stored in the cache so that such (approximate) membership can be readily obtained at a time of execution, thereby reducing any processing delays.

In some examples, the data processing apparatus comprises: load circuitry configured to replace the data value in the membership query circuitry based on a subset of bits of the memory address. The data value can thereby be loaded and approximate set membership established against this new value of the data value. This makes it possible for a number of different data values to be stored and used, which itself means that each data value can be encoded using a smaller number of memory addresses. As a consequence of this, it is possible to reduce the chance with which the approximate set membership query will indicate that an address may be one of the plurality of addresses when it is not.

In some examples, the membership query circuitry is configured to use at least one of a bloom filter, cuckoo filter, XOR filter, or decision tree. The decision tree may not be a complete decision tree, which is to say that it does not provide a definitive answer as to whether a memory address is within the plurality of memory addresses. Instead, it is able to provide some definitive information regarding set membership—but not all. For instance, this might be that a given memory address either is not within the set or might be within the set. In other examples, it may be that a given memory address is either in the set or might be within the set. The same is true of the bloom filter, cuckoo filter, and XOR filter, the details of which will be known to the skilled person.

Particular embodiments will now be described with reference to the figures.

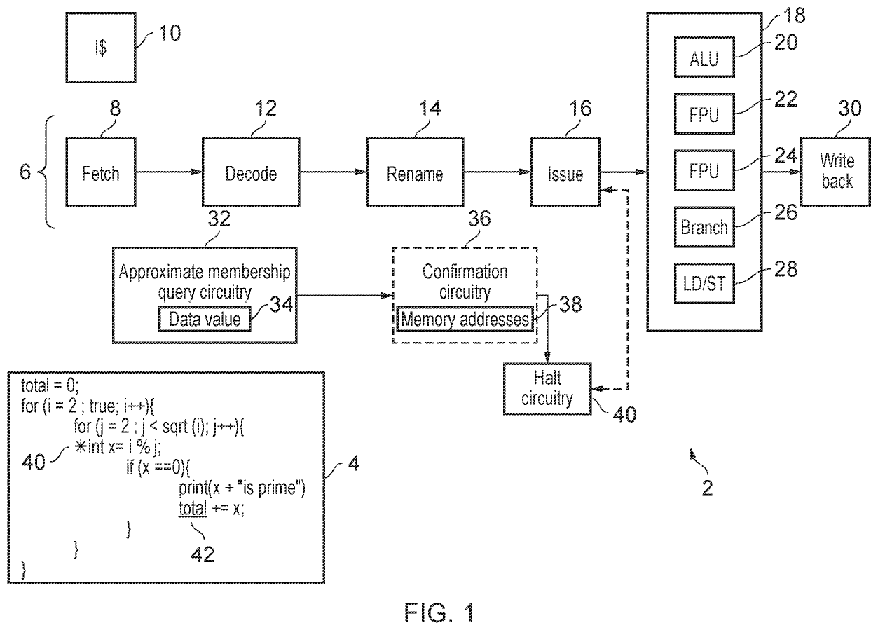

FIG. 1 illustrates an apparatus 2 in accordance with some examples. The apparatus includes a pipeline 6. Note that the specific makeup of the pipeline here is not relevant and the formulation shown in FIG. 1 is simply provided as an example. Within the pipeline, instructions are fetched by fetch circuitry 8 and decoded by decode circuitry 12 into one or more control signals. Renaming may optionally take place at rename circuitry 14 in order to remove false data dependencies, and the issue circuitry 16 then queues the control signals corresponding to the instructions to be executed by one or more execution circuits 18. In this example, the execution circuits include an arithmetic logic unit 20 for performing arithmetic and logical operations, a pair of floating point units 22, 24 for performing floating point operations, a branch unit 26 for performing branch operations and load/store unit 28 for accessing a memory (not shown). The execution units 18 illustrated here are only an example and other or additional units may be present and some units may be omitted. A writeback circuit 30 is then responsible for writing data back (e.g. to registers) as appropriate.

FIG. 1 also illustrates source code 4 that might be executed on the apparatus 2. The nature of the example code is unimportant but in this case outputs prime numbers in ascending order as well as the sum of prime numbers encountered so far. In developing this code, the programmer may wish to debug it—e.g. if the behaviour of the program is contrary to its intent. Two ways in which this may achieved is by the setting of breakpoints 40 (indicated by an asterisk in the source code) and watchpoints (indicated by underlining in the source code). A breakpoint causes execution of the program to halt so that the current state of the system can be examined. For instance, the values of particular variables can be examined. A watchpoint causes execution of the program to halt when a specified variable changes (or potentially when it changes to a given value, within a particular range, etc.). In both cases, the user is able to step through the program approximately one instruction at a time in order to see how the state of the system changes after execution of each instruction. Accordingly, both watchpoints and breakpoints are associated with memory addresses. In the case of a breakpoint, the memory address is the program counter address (e.g. virtual address) of the instruction having the breakpoint. In the case of a watchpoint, the memory address is the memory address associated with the variable.

It may be desirable for a programmer to be able to set a large number of breakpoints and watchpoints. In practice, this could be achievable by emulating the program entirely in software but this is slow and resource intensive. However, in the case of a hardware debugger, problems are encountered when a large number of breakpoints/watchpoints are present. In particular, at the execution of every single instruction, it is necessary to compare the program counter value to the list of breakpoints to see if execution should halt or not. This could potentially be achieved by checking the breakpoint list in series. However, this would lead to a long delay at the execution of each instruction. Alternatively, each of the breakpoints could be simultaneously checked in parallel. However, this requires a large amount of hardware. In each case, the slowness or circuit size is affected by the maximum number of breakpoints that are possible rather than the number of breakpoints actually used. Hence, even when a small number of breakpoints are present, the program will be debugged slowly or still require a large circuit. It is possible to reduce these difficulties by only allowing a small number of breakpoints, but this is inconvenient for debugging. Similar situations apply in respect of watchpoints. In particular, every memory access would also be tested to see if the address being accessed is one of the specified variables. This again either requires series checking (slow) or parallel checking (large circuit size). It may also be possible to use more complicated data structures such as performing tree-like comparisons on sorted arrays. In practice, however, this can still be time consuming and requires the memory addresses to be stored in a specific manner, which can make the addition and deletion of such addresses time consuming and burdensome.

The inventors of the present technique have realised that one way of solving this problem is to have an initial approximate check, which produces an initial estimate of whether an address is to cause a halt or not. Only if that check is passed is a confirmation check performed (e.g. in series). Hence, the number of occasions when a slowdown occurs is reduced.

In the current example, the approximate check (an approximate set membership check) is achieved by approximate membership query circuitry 32. This circuitry 32 maintains a data value 34 that is derived from the full set of memory addresses 38 at which a halt is to be performed. The check is approximate in the sense in that it does not return a definitive yes/no. Instead, one of the results that it returns is ‘maybe’. For instance, a positive result might be ‘maybe’ and a negative result might be ‘no’. So it is possible to determine that an address should not cause a halt (allowing execution to continue). If the approximate membership query circuitry 32 indicates that a given address might be one of the addresses at which a halt should occur then this can be confirmed via the confirmation circuitry 36 against a value or values 38 that provide a definitive answer. Importantly, the approximate membership query circuitry 32 is able to provide a result more quickly than the confirmation circuitry 36 can provide a result and hence, any slowdown is vastly reduced.

The confirmation circuitry 36 can take a number of different forms. In FIG. 1 it is shown as dedicated hardware that may form part of the hardware debugger. However in other examples, the confirmation circuitry 36 can take the form of software that executes, for instance, within the pipeline 6.

Halt circuitry 40 is provided that causes the pipeline to halt execution in response to a positive indication from the confirmation circuitry 36. This could take the form of a simple flag that indicates whether, for instance, instructions should be issued to the execution units. In some embodiments, the halt circuitry 40 may halt the entire pipeline. Other techniques will of course be known to the skilled person.

In practice, the halt may also depend on further parameters. That is to say that a further requirement may be required in addition to the instruction being one at which a halt should occur. For instance, in some circumstances it is possible to make halting conditional on the value of a variable.

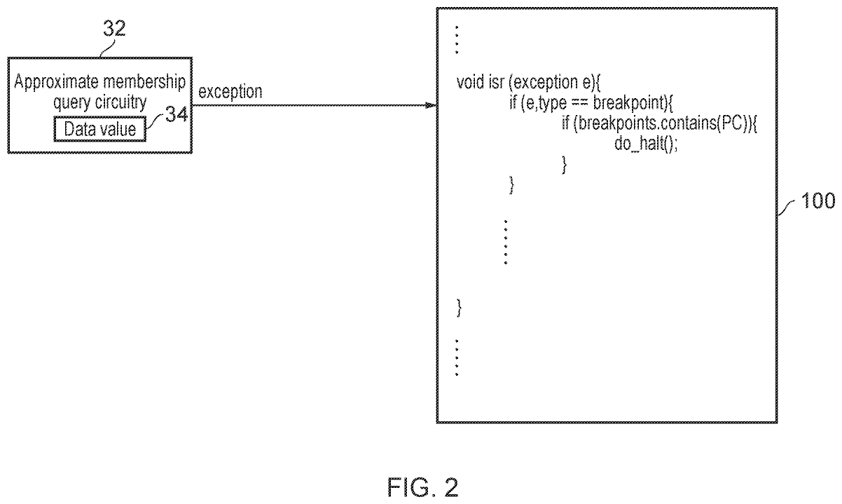

FIG. 2 shows an example in which the confirmation circuitry 36 takes the form of the pipeline 6. When the approximate membership query circuitry 32 provides a positive result, indicating that a given address might be one of the addresses that should cause a halt, an exception is signalled. This in turn causes an interrupt service routine 100 to be called, which determines (in software) if the address is one of the addresses that should cause a halt. In the example of FIG. 2, the check that is performed is whether the current program counter value is in the list of breakpoints. However, it will be appreciated that a full interrupt service routine would also confirm whether the address currently being accessed is one of the specified watchpoints. In either case, if this definitive check returns a positive result then a halt is called and otherwise the indication from the approximate membership query circuitry was a false positive and execution should resume.

For completeness, it will be appreciated that it is not necessary to perform this operation at the level of the operating system and the process could instead take place largely (or entirely) within user space. For instance, a signal could be transmitted to the debugger (operating in user space) to perform a software check on whether a halt should be called.

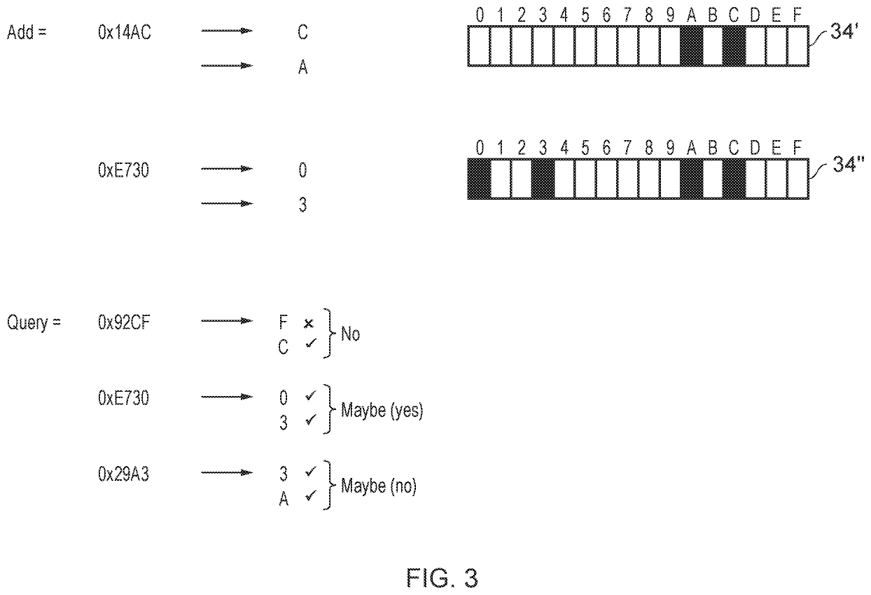

FIG. 3 shows an example of how an approximate set membership query might work. The example shown in FIG. 3 uses bloom filters. However, other techniques such as cuckoo filters, XOR filters, and even decision trees can be used to provide an approximate set membership query result. It will also be appreciated that there are a number of ways in which bloom filters might be implemented and FIG. 3 illustrates one particular example.

In FIG. 3, a number of hash functions are implemented. For the purposes of visibility, the first hash filter in this example simply returns the last hexadecimal digit of an address and the second hash filter simply returns the second last hexadecimal digit of an address. The skilled person will appreciate that these particular hash functions are not necessarily ideal but are provided for the purposes of understanding.

For a given address to be added to the bloom filter, each hash function is run on the memory address. This therefore returns two hashes. For instance, in the case of the address 0x14AC, the hashes ‘C’ and ‘A’ are returned. These hashes are then logically ORed with the data value 34 representing the bloom filter to provide a revised bloom filter data value 34′. It can be seen in this example that bits at indices 10(A) and 12(C) have been filled in, in the revised data value 34′.

At a next step, the address 0xE730 is added. In this case, the hashes are 0 and E and therefore these bits are logically ORed with the latest version of the data value 34′ representing the bloom filter to provide a further revised bloom filter data value 34″, in which each of bits at indices 0, 3, 10, and 12 have been marked.

To test for test membership, the same hash functions are applied to the data value being queried. For instance, in querying the address 0x92CF the hashes F and C are produced. The bit at index F (15) is not marked in the bloom filter data value 34″ and so this value is definitely not present in the bloom filter. In contrast, the data value 0xE730 (which was previously added) produces the hashes 0 and 3. Both of these bits are present and so the value might be present within the bloom filter data value 34″. As another example, the data value 0x29A3 produces the hashes 3 and A. The locations for both of these bits are marked in the bloom filter, and so the address 0x29A3 might be present. In fact, it is not (this was not one of the addresses that was added), demonstrating that the bloom filter does not give certainty when providing a positive result.

This also demonstrates that a confirmation check should be performed to confirm that a data value is part of the membership set. However, since the hashing operations of the approximate membership set can be performed more quickly that testing each address against a list of addresses, the number of occasions where a proper membership test needs to be performed can be significantly reduced.

The number of false positives can be improved by appropriate selection of the hash functions (and the number of hash functions) and by the selection of size of the bloom filter data value 34″. For example, a 768-bit filter that uses 16 different hash functions might expect a false positive rate of 9.5E-14 when the filter contains 8 elements and still only 0.098 when the filter contains 96 elements.

Other approximate set membership operations can also be selected such as Cuckoo filters, XOR filters, and decision trees.

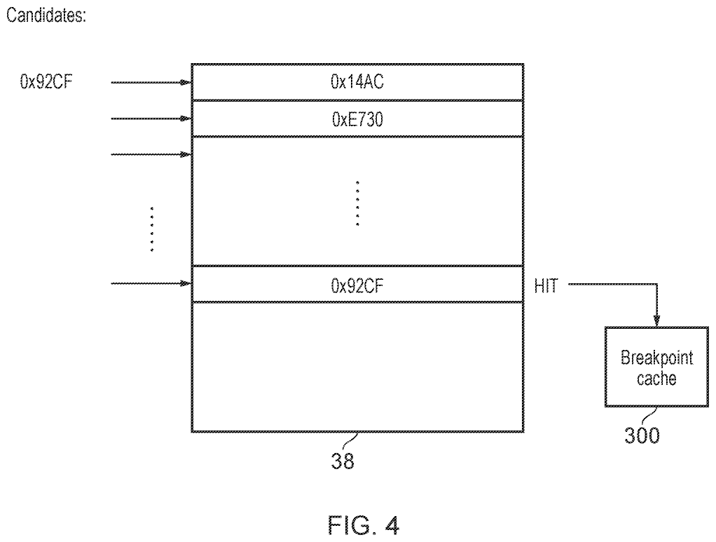

FIG. 4 illustrates how proper set membership can then be tested for using confirmation circuitry 36. In this example, having been notified that the approximate set membership query returned a positive result (‘maybe’), it is necessary to test the address against the memory addresses 38 to determine whether the suspected address is one of the addresses 38. In this example, the address 0x92CF is tested against the list (containing 0x14AC, 0xE730 and 0x92CF) and so a hit occurs on this latter address. Thus it is known that a halt should occur.

The checking via the confirmation circuitry 38 can be improved by the use of a cache 300. In this example, a breakpoint cache 300 stores most recently used breakpoints on the assumption that a recently used breakpoint is likely to be used again soon. Consequently, in parallel with checking the confirmation circuitry 36, the breakpoint cache 300 can also be checked to see if the incoming address matches the most recently used addresses. In other embodiments, the breakpoint cache 300 is checked before the confirmation circuitry 36 is checked. Also in other embodiments the cache 300 stores watchpoints. In other embodiments, a separate cache is used to store watchpoints to limit the displacement of breakpoints. Note that in most cases, it is expected that the cache 300 will be smaller and faster than checking the confirmation circuitry 38.

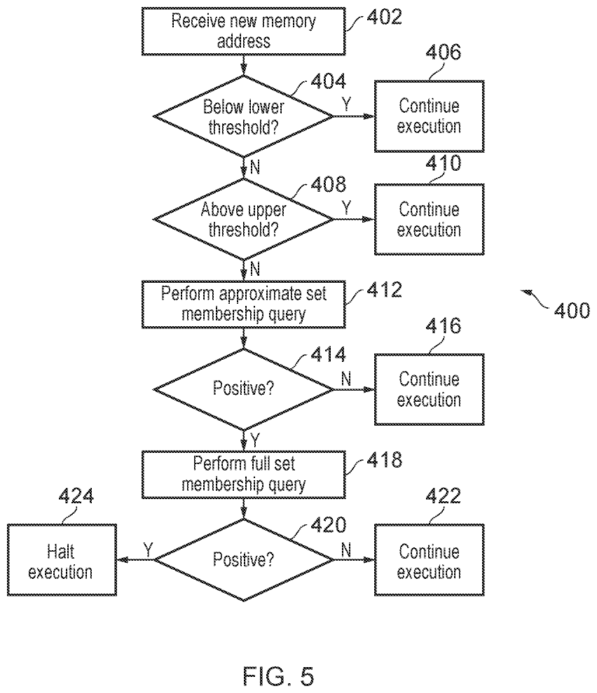

FIG. 5 shows a flow chart 400 that illustrates further improvements in the checking that is performed. In particular, it is recognised that upper and lower thresholds can be provided in order to ‘bound’ the checks that are performed. For instance, if it is known that the data value 34 does not contain any addresses within a particular space or if it is known that the list of memory addresses do not contain any addresses within a particular space (e.g. below a lower limit or above an upper limit) then checks can be made to avoid having to either check the data value or perform a confirmation with the confirmation circuitry 36.

At a step 402, a new memory address is received. This may be because the address is of a new instruction that is being executed or because it relates to a memory address that is being accessed. In any event, at step 404, it is determined whether this address falls below the lower threshold. If so, then execution continues at step 406 because neither the bloom filter nor the list of addresses 38 can cover the memory address. If the address is not below the lower threshold then at step 408, it is determined whether the address is above the upper threshold. If so, then at step 410, execution continues because the address cannot be one of the addresses that causes a halt. Otherwise, at step 412, an approximate set membership query is performed as previously discussed. If, at step 414, the result of this is not positive (e.g. if the result is ‘no’) then execution continues at step 416. Otherwise, if the result is positive (e.g. the result is ‘maybe’) then at step 418, a full set membership query is conducted using the confirmation circuitry 36. If the result of this is positive (e.g. ‘yes’) then at step 424, execution halts. Otherwise, the result is ‘no’ and so execution continues at step 422.

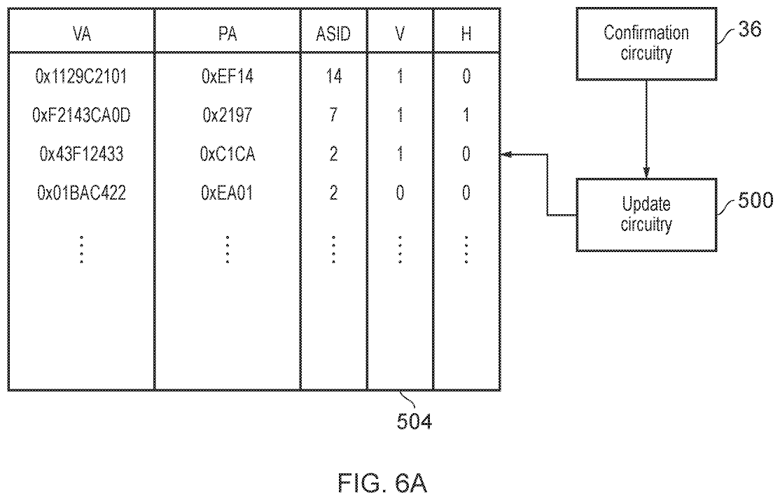

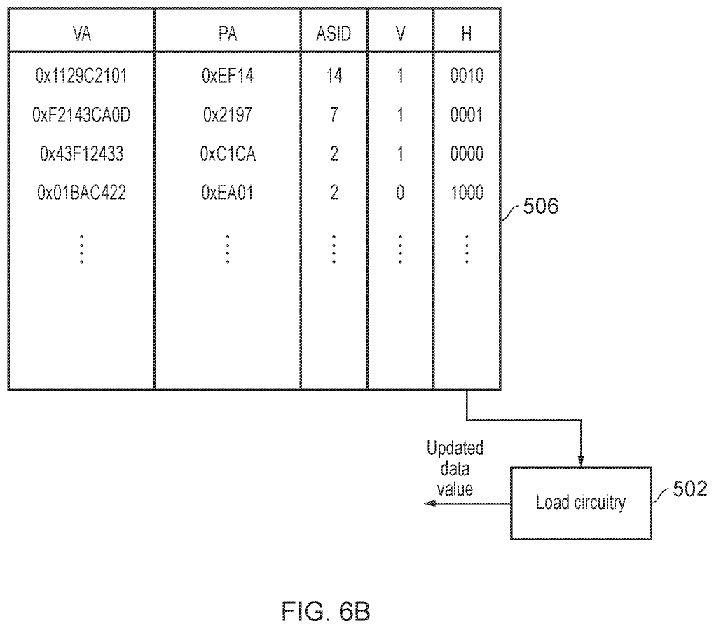

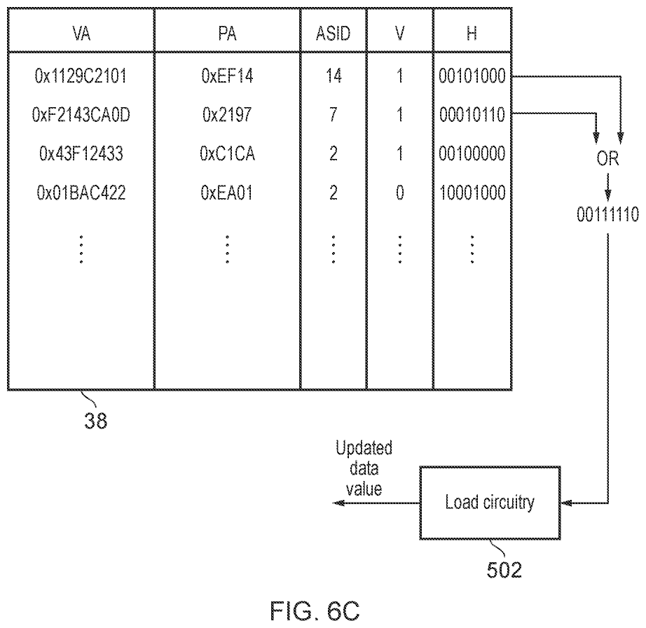

FIG. 6A illustrates one way in which page tables can be used to improve the previously described process. In FIG. 6A, each entry of a page table 504 contains an addition bit (H) that indicates whether the corresponding page contains a breakpoint or contains an address that is the subject of a watchpoint. As an additional check-either before the approximate membership query circuitry 32 is queried or before the confirmation circuitry 36 is queried, the page table entry is checked to see whether the bit is set (e.g. 1). If not, then no further checking needs to take place since it is known that the current address to be queried is not one for which a halt should be called.

In this example, update circuitry 500 is also provided. This allows for ‘memoisation’ in which the approximate set membership query and the actual set membership query are performed in advance of the instruction being executed and stored in the page table entry.

FIG. 6B illustrates an example that allows for the use of multiple data values. In particular, in FIG. 6B, each page table entry indicates which data value should be used for queries relating to that particular page. In FIG. 6B, a four-bit number is provided that allows for the selection of up to 15 different data values. However, a simpler implementation merely uses each bit position to indicate which data value to use. That is, 0001 refers to the first data value, 0010 refers to the second data value, and so on. The value ‘0000’ is reserved for ‘no data value’, i.e. because the page does not contain any breakpoints or watchpoints. Regardless of the encoding used, load circuitry 502 is then provided to update the data value 34 in the approximate membership query circuitry 32 with the data value selected according to the page table entry.

It will be appreciated that by providing a number of different data values that can be swapped in/out, the number of entries stored within each data value (i.e. the number of breakpoints/watchpoints per data value) can be reduced. In this way it is possible to reduce the number of instances of false positives, which is to say that the number of occasions where the confirmation circuitry 36 is queried for an address where a halt should not occur is further reduced.

FIG. 6C illustrates an example in which the data value 34 is dynamically constructed. In this example, each page table entry contains its own data value for addresses within that page. Each of the data values are bloom filters that are produced using a same set of hash functions and are a same length. Consequently, they can be logically ORed together. A data value 34 can then be constructed by logically ORing together all of the data values that relate to memory pages that relate to the instructions in, for instance, the instruction cache.

In this example, the instruction cache may contain instructions relating to the page 0xEF14, which also contains a memory access to an address in page 0x2197. Accordingly, the data values can be logically ORed together to produce a combined bloom filter 00111110. This is then provided by the load circuitry 502 as an updated data value 34 for use in executing the instructions in the instruction cache 10. Since it is not possible to hit a breakpoint (at least) on an instruction that is not in the instruction cache 10, the data value can be scoped to addresses that are currently executing.

Note that if the breakpoints or watchpoints are changed then in this situation, the instruction cache 10 would be flushed (or at least, the annotations would be reset to ‘1’).

Note that in many of the above cases, it is also possible to dynamically load the memory addresses 38 used by the confirmation circuitry 36. In particular, rather than storing a full list of addresses 38, the confirmation circuitry 36 could store a subset of the addresses, with the load circuitry 502 (for instance) being configured to load those addresses used to generate a replacement data value into the confirmation circuitry 36. This could help to increase the speed of the confirmation circuitry 36.

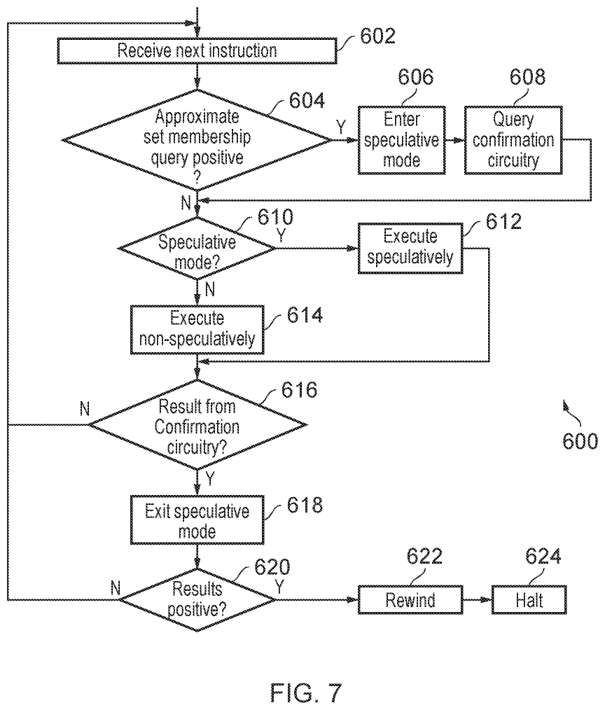

FIG. 7 illustrates an example of using speculative execution that can be used to improve the execution when a query is made to the confirmation circuitry 36, whose use is generally slow. At a step 602, an instruction is received. At a step 604, it is determined whether the approximate set membership query is positive or not. If so, then at step 606, speculative mode is activated and a query is sent to the confirmation circuitry to determine whether the address in question is one of those that ought to cause a halt. The process then proceeds to step 610, where the flow also goes to if the approximate set membership query is negative. At step 610, it is determined if speculative mode is active-either as a result of having just been activated or as a result of having been previously activated. If speculative mode is active then at step 612, the current instruction is executed speculatively. Otherwise at step 614 the instruction is executed non-speculatively. Either way, at step 618, it is determined whether a result from the confirmation circuitry has been received. If not, then the process returns to step 602 to obtain the next instruction. If so, then speculative mode ends at step 618. It is then determined whether the result is positive. If not, then the process simply returns to step 602 since the execution should not cause a halt. Any speculatively executed instructions are therefore commitable-they were speculatively executed appropriately. Otherwise, at step 622 a rewind occurs by flushing the pipeline thereby ‘undoing’ the speculative execution of instructions that should not have happened. Then the halt occurs at step 624.

In the manner described above, when the confirmation circuitry is to be queried, subsequent instructions are executed speculatively. Consequently, if it turns out that a halt is not to occur, then little to no processing time has been lost. Conversely, if a halt was to occur (which may be determined after some time due to the comparative slowness of the confirmation circuitry 36) then the pipeline can simply be flushed. Since a halt would have been due to take place anyway, no processing time is lost.

Note that the flowchart 600 illustrated in FIG. 7 does not directly represent the operation of the circuitry but rather the overall behaviour of the system. In practice, the steps shown in the flowchart 600 might actually be spread (and even operate independently) across numerous different systems.

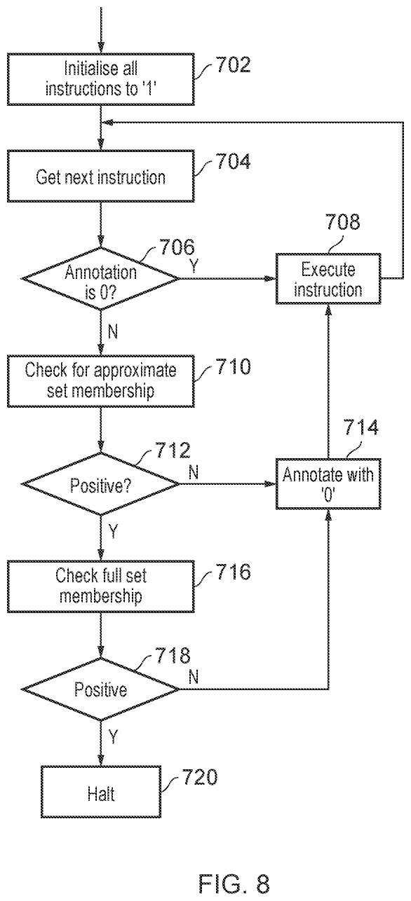

FIG. 8 shows a flowchart 700 that can be used for memoisation. At a step 702, all instructions (e.g. in the instruction cache) are initialised with a ‘1’ for instance. At step 704, a next instruction is fetched and at step 706 it is determined whether the annotation is ‘0’. If so, then the instruction has previously been determined to not be a breakpoint/watchpoint and so it is simply executed at step 708. The flow then returns to step 704 where the next instruction is obtained. Otherwise, if the annotation is not 0 (e.g. is 1) then at step 710, a test is made for approximate set membership. If, at step 712, this is not positive then the annotation is updated to be ‘0’ at step 714 and the flow proceeds to step 708 where the instruction is executed. If the result is positive then at step 716, full set membership is checked for. If this result is not positive then the flow proceeds to step 714 where the annotation is updated to ‘0’. Otherwise, a halt occurs at step 720 (and the annotation remains as ‘1’).

In this way, over time, the annotation comes to reflect whether the instruction is determined as being a watchpoint/breakpoint (1) or not (0). Rather than performing the formal check each time, the annotation is checked. If the annotation is provided in, for instance, an instruction cache 10 then this can be determined much more quickly than it can by checking the data value 34 each time.

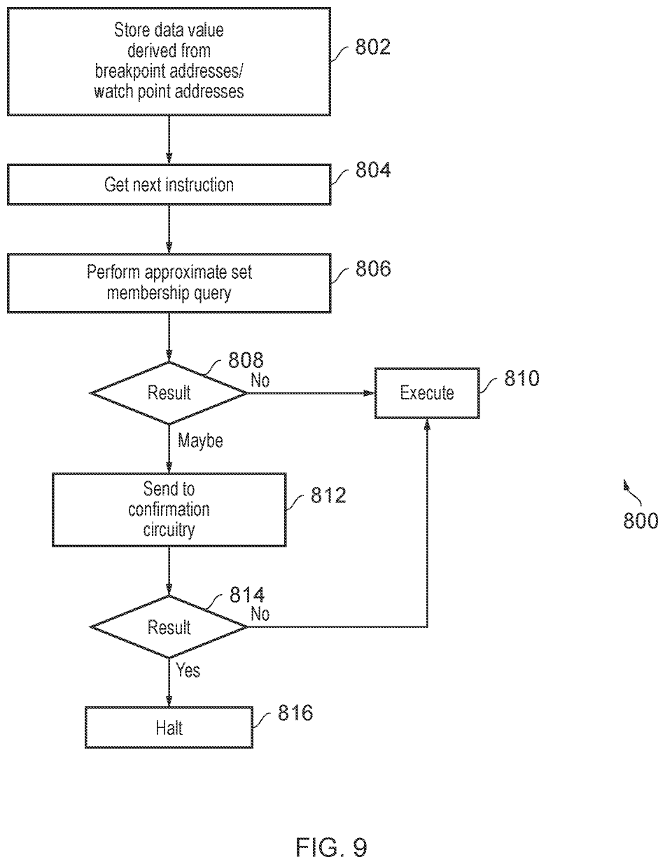

FIG. 9 shows a flowchart 800 that shows an overall process of data processing in accordance with some examples. At a step 802, a data value is stored. The data value is derived from addresses (e.g. of breakpoints and points where a watched data value may change) where a halt should occur. At a step 804, a next instruction is obtained. Then at a step 806, the approximate set membership query is performed. The approximate set membership query can be performed quickly, but only provides an initial estimate of whether an address is in the set of breakpoints/watchpoints. That is, it returns ‘maybe’ or ‘no’ for instance rather than ‘yes’ or ‘no’. If the result is ‘no’ then the instruction is executed at step 810. If the result is ‘maybe’ then at step 812, confirmation is sought from the confirmation circuitry. This check is expected to take longer, but the frequency of false positives (where a hit occurs in the approximate set membership query but not in the confirmation circuitry) is expected to be low.

Therefore, this slow query is anticipated to occur primarily where a halt would be due to occur anyway. Having sent the query to the confirmation circuitry at step 812, the result is checked at step 814. If the result is ‘no’, i.e. that the address is not one that a halt should occur at, then the instruction is executed at step 810. Otherwise a halt occurs at step 816.

Hence, it can be seen that it is possible to support a large number of breakpoints/watchpoints while still making it possible to quickly perform debugging using hardware.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

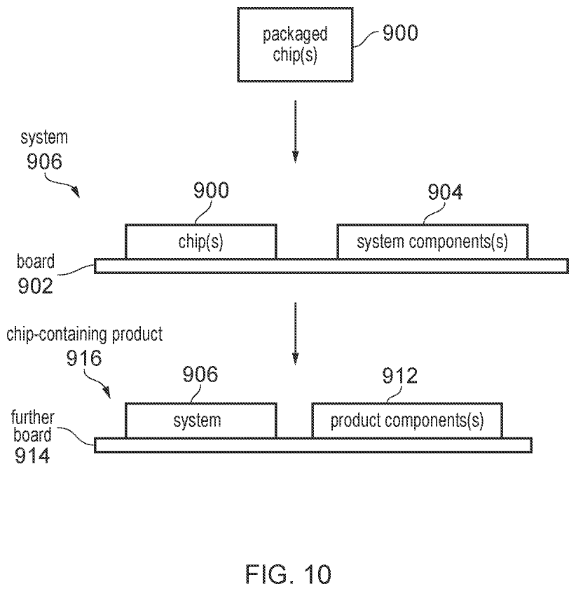

As shown in FIG. 10, one or more packaged chips 900, with the apparatus described above implemented on one chip or distributed over two or more of the chips, are manufactured by a semiconductor chip manufacturer. In some examples, the chip product 900 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 900 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 900 are assembled on a board 902 together with at least one system component 904 to provide a system 906. For example, the board may comprise a printed circuit board. The board substrate may be made of any of a variety of materials, e.g. plastic, glass, ceramic, or a flexible substrate material such as paper, plastic or textile material. The at least one system component 904 comprise one or more external components which are not part of the one or more packaged chip(s) 900. For example, the at least one system component 904 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 916 is manufactured comprising the system 906 (including the board 902, the one or more chips 900 and the at least one system component 904) and one or more product components 912. The product components 912 comprise one or more further components which are not part of the system 906. As a non-exhaustive list of examples, the one or more product components 912 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 906 and one or more product components 912 may be assembled on to a further board 914.

The board 902 or the further board 914 may be provided on or within a device housing or other structural support (e.g. a frame or blade) to provide a product which can be handled by a user and/or is intended for operational use by a person or company.

The system 906 or the chip-containing product 916 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

The system could be configured as follows:
(1) A data processing apparatus comprising:
   storage circuitry configured to store a data value derived from a plurality of memory addresses associated with a stream of instructions;
   membership query circuitry configured to perform an approximate set membership query against the data value of a memory address associated with a current one of the instructions and in response to the approximate set membership query being positive, to issue the memory address to confirmation circuitry; and
   halt circuitry configured to halt execution of the stream of instructions by processing circuitry in response to at least one condition being met, the at least one condition comprising a positive indication from the confirmation circuitry that the memory address is one of the plurality of memory addresses.
(2) The data processing apparatus according to (1), wherein
   the memory addresses comprise program counter values of those of the instructions at which a breakpoint is set.
(3) The data processing apparatus according to any of (1)-(2), wherein
   the memory addresses comprise locations within a memory at which data access requests are made by the instructions against which a watchpoint is set.
(4) The data processing apparatus according to any one of (1)-(3), comprising:
   the confirmation circuitry, wherein
   the confirmation circuitry is configured to store a further data value indicating the plurality of memory addresses.
(5) The data processing apparatus according to any one of (1)-(3), wherein
   in response to the approximate set membership query being positive, the membership query circuitry is configured to issue a signal to the confirmation circuitry; and
   a signal receiving routine at the confirmation circuitry is configured to determine whether the memory address is in the plurality of memory addresses.
(6) The data processing apparatus according to any of (1)-(5), wherein
   at least one of the membership query circuitry and the confirmation circuitry is configured to return a negative result indicating that the memory address is not one of the memory addresses in response to the memory address being below a lower limit.
(7) The data processing apparatus according to any of (1)-(6), wherein
   at least one of the membership query circuitry and the confirmation circuitry is configured to return a negative result indicating that the memory address is not one of the memory addresses in response to the memory address being above an upper limit.
(8) The data processing apparatus according to any of (1)-(7), wherein
   at least one of the membership query circuitry and the confirmation circuitry is configured to return a negative result indicating that the memory address is not one of the memory addresses based on memory page metadata of the memory address.
(9) The data processing apparatus according to (8), comprising:
   page table circuitry configured to store a plurality of page table entries, wherein of the page table entries is configured to store an indication of whether a corresponding memory page contains one of the memory addresses.
(10) The data processing apparatus according to (8), comprising:
   page table circuitry configured to store a plurality of page table entries, wherein
   the membership query circuitry is configured to perform the approximate set membership query against a plurality of data values including the data value; and
   the page table entries comprise a hint that indicates a set of the plurality of data values against which the approximate set membership query is to be performed for the memory address.
(11) The data processing apparatus according to any one of (8)-(9), comprising:
   update circuitry configured to store an outcome of one or both of the membership query circuitry and the confirmation circuitry for one of the page tables in response to execution of instructions corresponding to the one of the page tables.
(12) The data processing apparatus according to any of (1)-(11), wherein
   in response to issuing the memory address to the confirmation circuitry, the data processing apparatus is configured to enter a speculative mode of operation in which those of the instructions after the current one of the instructions are executed speculatively until a response from the confirmation circuitry is received.
(13) The data processing apparatus according to (12), wherein
   the data processing apparatus is configured, in response to the confirmation circuitry determining that the memory address is one of the memory addresses, to perform a rewind on those of the instructions after the current one of the instructions, that were speculatively executed.
(14) The data processing apparatus according to any of (1)-(13), comprising:
   cache circuitry, wherein
   at least one of the membership query circuitry and the confirmation circuitry is configured to determine whether given memory addresses whose contents are stored in the cache circuitry are in the instructions, in response to a cache miss.
(15) The data processing apparatus according to (14), wherein
   the cache circuitry is configured to store an indication of whether the given memory addresses are in the instructions.
(16) The data processing apparatus according to (1)-(15), comprising:
   load circuitry configured to replace the data value in the membership query circuitry based on a subset of bits of the memory address.
(17) The data processing apparatus according to any of (1)-(16), wherein the membership query circuitry is configured to use at least one of a bloom filter, cuckoo filter, XOR filter, or decision tree.
(18) A method comprising:
   storing a data value derived from a plurality of memory addresses associated with a stream of instructions;
   performing an approximate set membership query against the data value of a memory address associated with a current one of the instructions and in response to the approximate set membership query being positive, to issue the memory address to confirmation circuitry; and
   halting execution of the stream of instructions by processing circuitry in response to at least one condition being met, the at least one condition comprising a positive indication from the confirmation circuitry that the memory address is one of the plurality of memory addresses.
(19) A non-transitory computer-readable medium storing computer-readable code for fabrication of a data processing apparatus comprising:
   storage circuitry configured to store a data value derived from a plurality of memory addresses associated with a stream of instructions;
   membership query circuitry configured to perform an approximate set membership query against the data value of a memory address associated with a current one of the instructions and in response to the approximate set membership query being positive, to issue the memory address to confirmation circuitry; and
   halt circuitry configured to halt execution of the stream of instructions by processing circuitry in response to at least one condition being met, the at least one condition comprising a positive indication from the confirmation circuitry that the memory address is one of the plurality of memory addresses.
(20) A system comprising:
   the data processing apparatus of any one of (1)-(17), implemented in at least one packaged chip;
   at least one system component; and
   a board, wherein
   the at least one packaged chip and the at least one system component are assembled on the board.
(21) A chip-containing product comprising the system of (20), wherein
   the system is assembled on a further board with at least one other product component.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. A data processing apparatus comprising:
storage circuitry configured to store a data value derived from a plurality of memory addresses associated with a stream of instructions;
membership query circuitry configured to perform an approximate set membership query against the data value of a memory address associated with a current one of the instructions and in response to the approximate set membership query being positive, to issue the memory address to confirmation circuitry; and
halt circuitry configured to halt execution of the stream of instructions by processing circuitry in response to at least one condition being met, the at least one condition comprising a positive indication from the confirmation circuitry that the memory address is one of the plurality of memory addresses.

2. The data processing apparatus according to claim 1, wherein
the memory addresses comprise program counter values of those of the instructions at which a breakpoint is set.

3. The data processing apparatus according to claim 1, wherein
the memory addresses comprise locations within a memory at which data access requests are made by the instructions against which a watchpoint is set.

4. The data processing apparatus according to claim 1, comprising:
the confirmation circuitry, wherein
the confirmation circuitry is configured to store a further data value indicating the plurality of memory addresses.

5. The data processing apparatus according to claim 1, wherein
in response to the approximate set membership query being positive, the membership query circuitry is configured to issue a signal to the confirmation circuitry; and
a signal receiving routine at the confirmation circuitry is configured to determine whether the memory address is in the plurality of memory addresses.

6. The data processing apparatus according to claim 1, wherein
at least one of the membership query circuitry and the confirmation circuitry is configured to return a negative result indicating that the memory address is not one of the memory addresses in response to the memory address being below a lower limit.

7. The data processing apparatus according to claim 1, wherein
at least one of the membership query circuitry and the confirmation circuitry is configured to return a negative result indicating that the memory address is not one of the memory addresses in response to the memory address being above an upper limit.

8. The data processing apparatus according to claim 1, wherein
at least one of the membership query circuitry and the confirmation circuitry is configured to return a negative result indicating that the memory address is not one of the memory addresses based on memory page metadata of the memory address.

9. The data processing apparatus according to claim 8, comprising:
page table circuitry configured to store a plurality of page table entries, wherein of the page table entries is configured to store an indication of whether a corresponding memory page contains one of the memory addresses.

10. The data processing apparatus according to claim 8, comprising:
page table circuitry configured to store a plurality of page table entries, wherein
the membership query circuitry is configured to perform the approximate set membership query against a plurality of data values including the data value; and
the page table entries comprise a hint that indicates a set of the plurality of data values against which the approximate set membership query is to be performed for the memory address.

11. The data processing apparatus according to claim 8, comprising:
update circuitry configured to store an outcome of one or both of the membership query circuitry and the confirmation circuitry for one of the page tables in response to execution of instructions corresponding to the one of the page tables.

12. The data processing apparatus according to claim 1, wherein
in response to issuing the memory address to the confirmation circuitry, the data processing apparatus is configured to enter a speculative mode of operation in which those of the instructions after the current one of the instructions are executed speculatively until a response from the confirmation circuitry is received.

13. The data processing apparatus according to claim 12, wherein
the data processing apparatus is configured, in response to the confirmation circuitry determining that the memory address is one of the memory addresses, to perform a rewind on those of the instructions after the current one of the instructions, that were speculatively executed.

14. The data processing apparatus according to claim 1, comprising:
cache circuitry, wherein
at least one of the membership query circuitry and the confirmation circuitry is configured to determine whether given memory addresses whose contents are stored in the cache circuitry are in the plurality of memory addresses, in response to a cache miss.

15. The data processing apparatus according to claim 14, wherein
the cache circuitry is configured to store an indication of whether the given memory addresses are in the plurality of memory addresses.

16. The data processing apparatus according to claim 1, comprising:
load circuitry configured to replace the data value in the membership query circuitry based on a subset of bits of the memory address.

17. A method comprising:
storing a data value derived from a plurality of memory addresses associated with a stream of instructions;
performing an approximate set membership query against the data value of a memory address associated with a current one of the instructions and in response to the approximate set membership query being positive, to issue the memory address to confirmation circuitry; and
halting execution of the stream of instructions by processing circuitry in response to at least one condition being met, the at least one condition comprising a positive indication from the confirmation circuitry that the memory address is one of the plurality of memory addresses.

18. A non-transitory computer-readable medium storing computer-readable code for fabrication of a data processing apparatus comprising:
storage circuitry configured to store a data value derived from a plurality of memory addresses associated with a stream of instructions;
membership query circuitry configured to perform an approximate set membership query against the data value of a memory address associated with a current one of the instructions and in response to the approximate set membership query being positive, to issue the memory address to confirmation circuitry; and
halt circuitry configured to halt execution of the stream of instructions by processing circuitry in response to at least one condition being met, the at least one condition comprising a positive indication from the confirmation circuitry that the memory address is one of the plurality of memory addresses.

19. A system comprising:
the data processing apparatus of claim 1, implemented in at least one packaged chip;
at least one system component; and
a board, wherein
the at least one packaged chip and the at least one system component are assembled on the board.

20. A chip-containing product comprising the system of claim 19, wherein
the system is assembled on a further board with at least one other product component.
